(19) United States
(12) Patent Application Publication
(10) Pub. No.: US 2013/0200286 A1
(43) Pub. Date: Aug. 8, 2013

(54) HIGH PRESSURE BALL VALVES AND RELATED SYSTEMS AND METHODS OF USE

(71) Applicant: Duane M. Eagen, Norman, OK (US)

(72) Inventor: Duane M. Eagen, Norman, OK (US)

(21) Appl. No.: 13/365,296

(22) Filed: Feb. 3, 2012

(51) Int. Cl. F16K 5/06; F16K 41/00; F16K 31/44

(52) U.S. Cl. 251/315.08; 251/315.1; 251/315.16; 251/214

(57) ABSTRACT

Disclosed herein is an improved ball valve with trunnions connected to impact turn wheels. The trunnions are affixed to the ball of the ball valve mechanism. The improved ball valve impact turn wheels will generate increased torque which will allow improved operation of a ball valve in high pressure applications.

### FIELD

The invention relates generally to ball valves, related systems, and methods of use. In particular the invention relates to improved ball valves with turn wheels which result in increased torque for turning the ball in high pressure applications.

### BACKGROUND

Ball valves are known in the art, and have traditionally been used as an effective mechanism for regulating fluid flow in various conduits. Various structural arrangements have been achieved for interrupting fluid flow by twisting a handle of a ball valve, and resuming fluid flow by twisting the handle back again. Typically, ball valves include a housing having an inlet port and an outlet port. A throughbore internally connects the inlet port to the outlet port. An inlet conduit and an outlet conduit may be connected to the inlet port and the outlet port respectively. A central chamber is positioned in the path of the throughbore. A ball with a throughbore is positioned within the central chamber. The ball may be rotated by an external handle. When the handle is twisted to align the throughbore of the ball with the path of the throughbore, the throughbore is uninterrupted and fluid may flow between the inlet and outlet ports. When the handle is twisted so that the slot lies perpendicular to the throughbore, fluid flow is interrupted.

Three-way ball valves have an L- or T-shaped hole through the middle. Typically, a T valve can connect any pair of ports, or all three, together. The 45 degree position typically disconnects all three valves. Generally, the L valve can connect the center port to either side port, or disconnect all three, but it cannot connect the side ports together.

Multi-port ball valves with 4 ways, or more, are also commercially available, the inlet way often being orthogonal to the plane of the outlets. For special applications, such as driving air-powered motors from forward to reverse, the operation is performed by rotating a single lever four-way valve. The 4-way ball valve has two L-shaped ports in the ball that do not interconnect, sometimes referred to as an “x” port.

Typically, ball valves are employed to open or close to enable or block a flow of fluid in a variety of applications. Ball valves commonly include a body, an adapter, a rotatable ball disposed within the body and adapter, and a stem coupled to the ball. However, when the ball rotates within the ball valve to block the flow of fluid, fluid under pressure may often become trapped in a body cavity of the ball valve. The trapped fluid may increase the pressure under temperature variations, increasing the torque required to actuate the ball.

Those skilled in the art will realize that ball valves are generally considered not to be functional for oil and gas operations due to the pressures in the conduits or lines, contaminants, and/or the like. The fluid produced from many geological formations contains minute, abrasive particles, such as sand, which lodge between the ball and seat and wear away the valve components. Over a period of time, the rotational ability of prior art valves may be reduced, thus requiring higher torque to turn such a valve. In some wells, where the production fluid is particularly sandy or corrosive, these ball valves may be particularly prone to a decrease in rotational ability.

Under such aforementioned conditions, manually operated valves can be difficult to open or close. The valve may stick, freeze, corrode or be used so rarely that its internal parts become fused. Additionally, problems with size and location are also encountered. Large valves are more difficult to operate, and inaccessible overhead valves can pose a particularly frustrating and potentially dangerous situation.

In certain higher pressure applications involving ball valves, a particular type of ball valve is used incorporating a trunnion ball which has additional mechanical anchoring of the ball at the top and bottom. One particular advantage of a ball valve incorporating a ball and trunnion mechanism is that when spaced in the same longitudinal axis, the trunnions can act to prevent drift upwards or downwards within the ball valve casing by providing a balancing mechanism.

In applications involving ball valves subjected to high pressure, or corrosive or other environments lending to stuck valves, it would be desirable to increase the torque applied to such valves in order to achieve rotation of the ball.

In oil and gas development or operations, time is money. The longer it takes to perform a task the more money that is being spent. Currently in many high pressure petroleum applications gate valves are used which require a hand wheel to open and/or close the gate valve. Workers in such fields may often open and close gate valves under high pressures of greater than 5,000 psi. Often the time required to open and/or close the gate valve is in the range of 7-60 minutes due to the number of hand wheel turns required to open and/or close the gate valve. The art field is in need of a valve that can be opened and/or closed in a shorter amount of time.

A valve capable of opening more quickly or with less effort would be beneficial in the art field. In general, a ball valve is capable of opening at a 90 degree turn. A Ninety (90) degree turn will take only a fraction of the number of hand wheel turns as compared to a gate valve. Consequently, the length of time required to open or close the valve is also greatly reduced. It would therefore be advantageous to use a ball valve which would have a quicker open and close time in high pressure petroleum applications.

### SUMMARY

In general, various embodiments of the present invention relate to an improved valve for use in high pressure applications. Various embodiments of the present invention generally relate to a ball valve comprising a ball valve case having at least one valve bore and a ball situated within the ball valve case. In such embodiments the ball has a throughbore which defines a flow axis. Still further, the ball valve preferably possesses a first trunnion having a proximal end attached to the ball and a distal end extending away from the ball and through a first trunnion bore; and a second trunnion having a proximal end attached to the ball and a distal end extending away from the ball and through a second trunnion bore, wherein said first trunnion and said second trunnion define a trunnion axis. Additionally, the ball valve may comprise a first impactor turn wheel attached to the distal end of said first trunnion and a second impactor turn wheel attached to the distal end of said second trunnion. In such embodiments, the impact turn wheels may each have one or more hammers and one or more strike bars. Alternatively, in certain embodiments, the strike bars may be located on the trunnions. In either embodiment, when the flow axis of the ball throughbore is at least partially aligned with respect to the flow axis of the valve bores, a fluid is capable of flowing through the ball valve case.

In certain further embodiments, the proximal end of a trunnion is attached to a ball by machining or casting or forging. In other embodiments, the attachment of a trunnion to the ball is mediated by a wedge shaped trunnion connection at the proximal end of the trunnion fitting into a retaining groove located on the ball.

In some embodiments, the trunnions may have axial movement dampeners within the case of the ball valve such that the ball is prevented from movement along the trunnion axis.

Regarding the ball valve body itself, in certain embodiments the ball valve case comprises a valve bore having a diameter less than a diameter of said ball.

In embodiments of the invention it is contemplated that the ball may be made of any hard or otherwise incompressible material. In preferred embodiments, the incompressible material is steel or an steel alloy. However, in general, the material may comprise any material, depending upon the fluid contained within the conduit or line and the pressure and temperature of said fluid.

Other embodiments of the invention contemplate a ball valve wherein the ball valve case comprises two halves. In such embodiments, each half has a proximal and distal end. The proximal ends may face each other and be attached to one another via a bifurcated flange. In such embodiments, the bifurcated flanges may be bifurcated by two semicircular notches 180 degrees apart such that when the two halves are attached, the two semicircular notches define two trunnion bore 180 degrees apart from each other. In such embodiments, the trunnions optionally may be protected by trunnion protecting sheathes attached to the exterior of the valve case and extending at least partially to the distal end of the trunnions.

Another embodiment of the invention contemplates a unibody valve case capable of receiving a ball. In specific embodiments, the trunnions possess wedge shaped trunnion connectors which are affixed to retaining grooves on the ball when the ball is received by the ball valve case. In such embodiments, the ball may be enclosed within the ball valve case by one or more seats which are adjacent to the ball and within the ball valve case. In this embodiment, the trunnions may be protected via trunnion protecting sheaths attached to the exterior of the valve case.

In many embodiments of the invention, the trunnion bore is surrounded by a bonnet. Additively, in many embodiments, a packaging gland surrounds each trunnion and is affixed to each bonnet, such that each trunnion bore possesses a trunnion, a packaging gland and a bonnet. Still further, in many embodiments of the invention, each trunnion is at least partially surrounded by one or more wear bushings. Still further, in many embodiments, each trunnion is at least partially surrounded by bearings.

In various further embodiments, the trunnions of the ball valve are connected to motors or other mechanisms for automating the opening and closing of the ball valve.

Other embodiments of the invention relate to a high pressure control system comprising a ball valve of one of the embodiments described above for adjusting the flow of a fluid from an upstream high pressure environment to a downstream lower pressure environment. In certain embodiments, the control system is employed at a petroleum producing facility. In certain other embodiments, the system is employed at a wellhead. In other embodiments the system is employed at a fracking operation.

Still other embodiments of the invention relate to a system comprising an inlet conduit affixed to the first valve bore of one the aforementioned valve embodiments and an outlet conduit affixed to the second valve bore of one of the aforementioned embodiments in a fracking operation for changing a pressure of a fluid flowing from the inlet conduit, through the valve and to the outlet conduit; wherein the pressure of the fluid flowing though the outlet conduit is changed from 0 psi to the about the same pressure of the fluid flowing from the inlet conduit or vice versa.

Still other embodiments of the invention relate to a system comprising an inlet conduit affixed to the first valve bore of one of the aforementioned valve embodiments and an outlet conduit affixed to the second valve bore of one of the aforementioned valve embodiments in a Christmas tree petroleum producing apparatus mounted above a wellhead for changing a pressure of a fluid flowing from the inlet conduit, through the valve and to the outlet conduit, wherein the pressure of the fluid flowing through the outlet conduit is changed from about 0 psi to about the same pressure of the fluid flowing from the inlet conduit or vice versa.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the invention are obtained, a more particular description of the invention briefly described above will be rendered by reference to specific embodiments thereof which are illustrated in the appended drawings. Understanding that these drawings depict only typical embodiments of the invention and are therefore not to be considered limiting of its scope, the invention will be described with additional specificity and detail through the use of the accompanying drawings in which:

FIG. 1 is an illustration of one half of a ball valve case;

FIG. 2 is an illustration of two halves of a ball valve case bolted together;

FIG. 3 is an illustration of a unibody ball valve case;

FIG. 4 is an illustration of a ball and trunnion component;

FIG. 5 is an illustration of a complete ball valve with impact turn wheels; and

FIG. 6 is a cross sectional illustration of a seated ball valve case.

### LIST OF REFERENCE NUMERALS

10 half of a ball valve case

11 valve bore

12 flow axis

13 proximal end of a valve bore

14 distal end of a valve bore

15 threaded bolt holes

16 bifurcated flange

17 two rounded trunnion notches

18 trunnion axis

20 trunnion bore

30 unibody ball valve case

12 flow axis

31 case opening

32 valve cap

15 threaded bolt holes

33 interior threading

40 ball and trunnion component

41 ball

42 throughbore

43 proximal trunnion

44 distal trunnion

45 turn wheel mount

47 wedge shaped trunnion connector

48 retaining groove

49 trunnion axial movement dampener

50 impact turn wheels

51 inner wall

52 outer wall

53 handles

54 hammer

55 strike bar

56 trunnion protecting sheath

60 seat

61 end closure

62 packing gland

63 bonnet

64 wear bushings

65 bearings

### DETAILED DESCRIPTION

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein the term, “hydraulic fracturing” (also called “fracking”), a method for extracting oil and natural gas.

As used herein, the term “pipe” means and refers to a fluid flow path.

As used herein, the term “conduit” means and refers to a fluid flow path.

As used herein, the term “line” means and refers to a fluid flow path.

As used herein, the term “fluid” refers to a non-solid material such as a gas, a liquid or a colloidal suspension capable of being transported through a pipe, line or conduit. Examples of fluids include by way of non-limiting examples the following: natural gas, propane, butane, gasoline, crude oil, mud, water, nitrogen, sulfuric acid and the like.

As used herein, the term “attached,” or any conjugation thereof describes and refers to the at least partial connection of two items.

Various embodiments of the present invention generally relate to methods, devices and/or systems for increasing the amount of torque which can be applied to a ball valve, such as a stuck or partially stuck ball valve or a ball valve which resists low torque rotation.

In certain embodiments, the ball within the ball valve may have trunnions above and below the ball or perpendicular to the fluid or gas flow through the valve.

In certain further embodiments, the trunnions extend through the ball valve casing and protrude from the ball valve in opposite directions. Still further, in certain embodiments the distal ends of the trunnions, which is defined as the ends of the trunnions furthest away from the ball are attached or otherwise affixed to turn wheels, such that the trunnions form the center axis of the wheels. In certain embodiments, the wheels are at the absolute distal ends of the trunnions and are affixed to the trunnions. In certain other embodiments, the wheels are at a position distal to the ball and the valve case, but are intermediate to the extreme distal end of the trunnions. The wheels may be bolted, welded, screwed, pinned to the trunnions or mounted on tapered distal ends of the trunnions wherein the center of the wheel receives the tapered distal end, such that turning the wheel or wheels applies torque to the trunnions and results in rotation of the ball within the ball valve.

In certain other embodiments, an impactor turn wheel is employed to provide torque to rotate the ball within the ball valve. In such embodiments, when only one impactor turn wheel is employed, a trunnion type ball valve may or may not be used. In lieu of a trunnion type ball valve, a floating ball valve with a valve stem may be employed when only one impactor turn wheel is employed.

An impactor turn wheel has an impact target that is directly coupled to the valve stem. The turn wheel pushes against the impact target to apply the torque. After the valve has been closed to a partial-tight position, the turn wheel is backed off a bit (<½ turn, typically) but the impact target stays in position (i.e. valve remains partially closed). The turn wheel is then spun quickly in the closing direction so that is ‘impacts’ the impact target providing the much higher torque required to properly seat the valve. In large or high pressure valves, it may take several men to apply the torque required with a standard turn wheel. With the impactor turn wheel, the instantaneous torque applied when the turn wheel strikes the impact target can be as much 10 times greater than one person could apply with a standard turn wheel.

The series of turns can be reversed to move the ball valve in the opposite direction.

In certain embodiments, the impactor turn wheel may have a single impact target such that the turn wheel can be rotated nearly 360 degrees before striking the impact target. In other embodiments, the impactor turn wheel may have two impact targets located 180 degrees from each other such that the turn wheel can be rotated nearly 180 degrees before striking the impact target. Alternative embodiments exist with a higher number of impact targets wherein the impact targets are spaced at equidistant angles from each other around the valve stem.

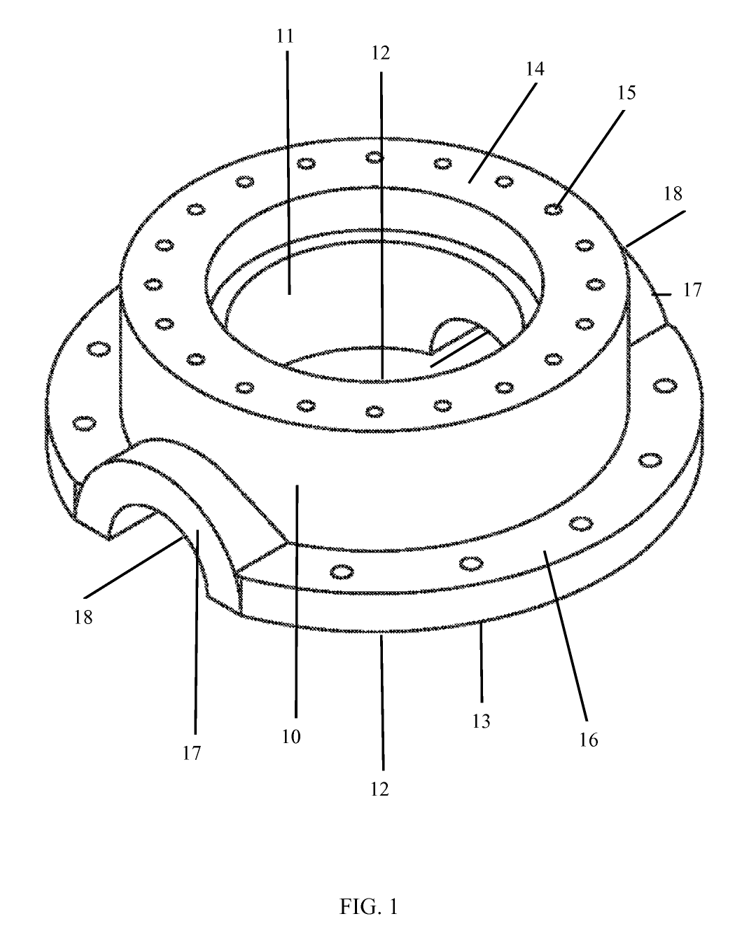

As shown in FIG. 1 is one half of a ball valve case 10 of one embodiment of the present invention. Depicted in this figure is a valve bore 11 having a flow axis 12, with a proximal end 13 toward the location of a ball (not shown), and a distal end 14 with threaded bolt holes 15 for attaching a pipe (not shown) such as through the use of a pipe flange (not shown). Also depicted in this figure is a bifurcated flange 16 attached to the proximal end 13 of the valve bore with holes for accepting nuts and bolts and two rounded trunnion notches 17. The two rounded trunnion notches 17 being positioned along a trunnion axis 18 perpendicular to the flow axis 12.

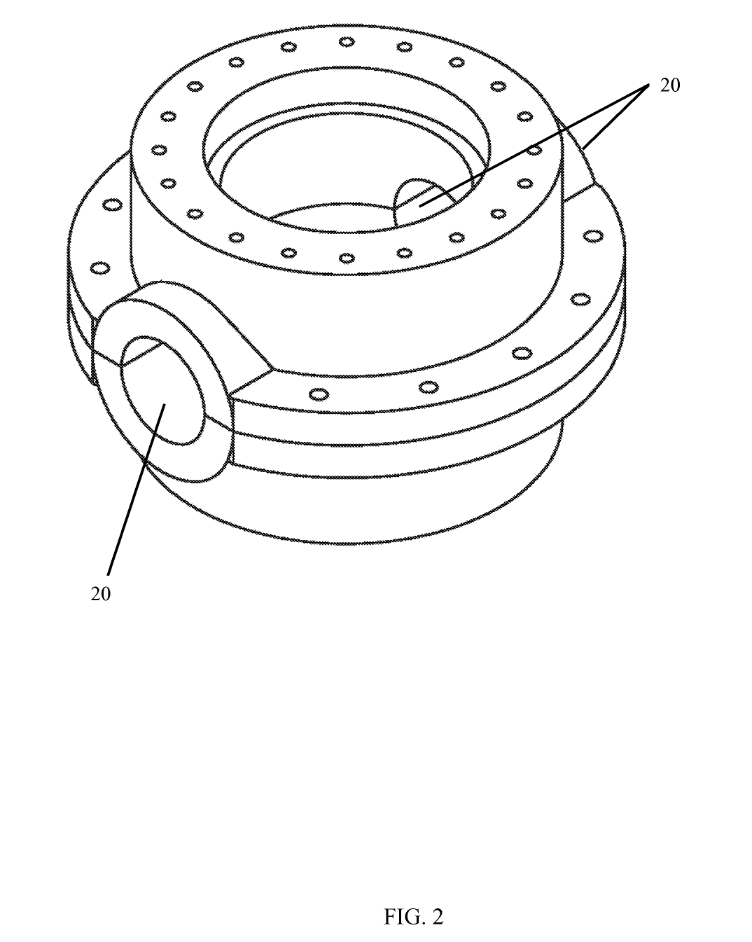

As shown in FIG. 2, two halves of the ball valve case are fitted together at their proximal ends and depicting a bolt and nut through the bifurcated flanges. While bolting the two halves of the ball valve case is illustrated, it is contemplated that in certain embodiments, other manners of connecting the two halves may be employed, such as welding or use of a clamp ring. The two halves of the ball valve case are fitted together such that the rounded trunnion notches are directly facing each other to form a trunnion bore 20 on each side of the ball valve case.

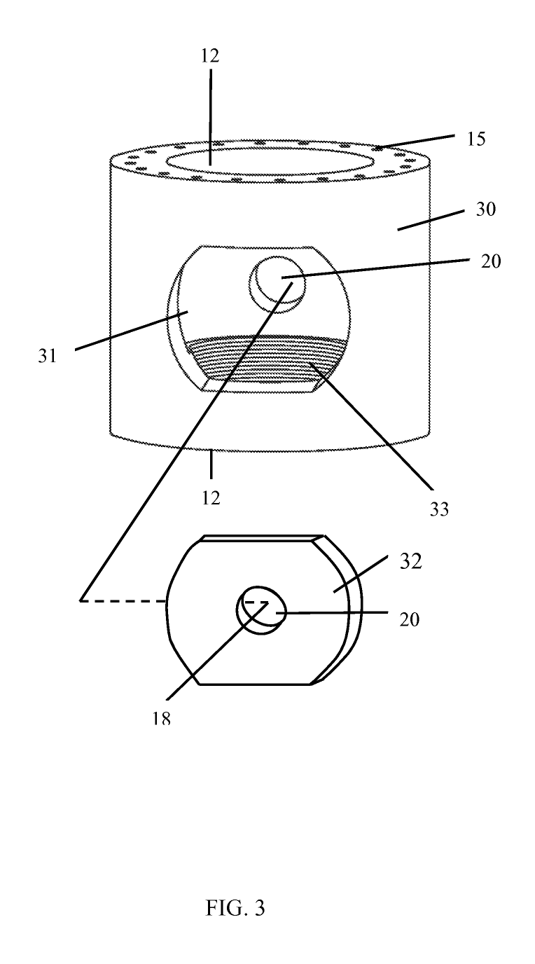

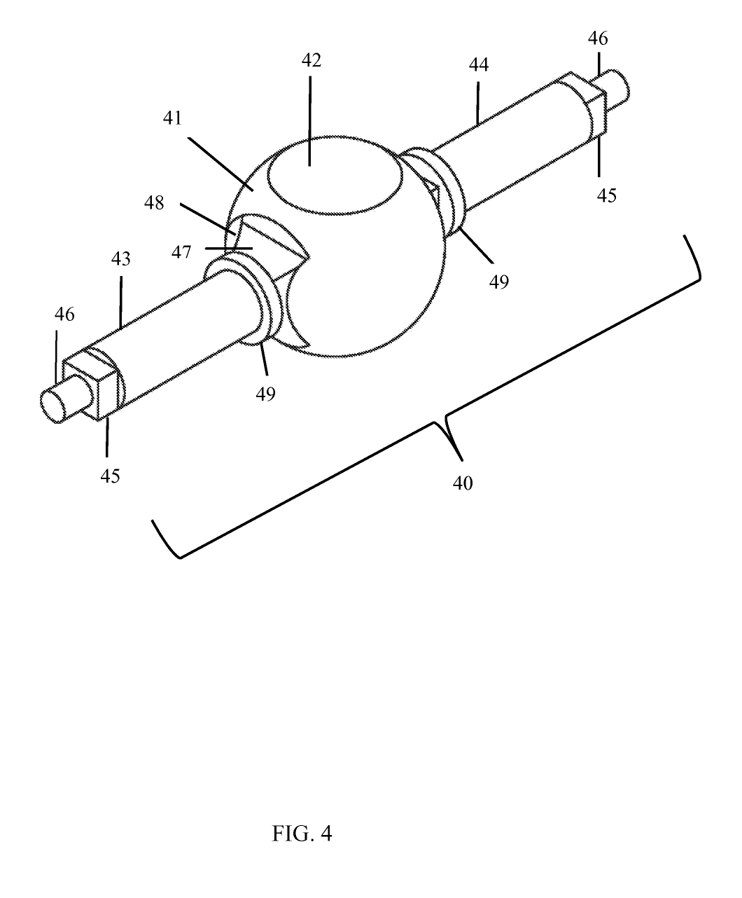

An alternative embodiment of a ball valve case is shown in FIG. 3. In this embodiment, the ball valve case may be considered a unibody ball valve case 30. As further depicted in FIG. 3, the unibody ball valve case 30 may have a flow axis 12 and an trunnion axis 18 which is perpendicular to the flow axis 12 and which is aligned with the axis of the ball and trunnion component on opposite sides of the ball (not shown). Further depicted in FIG. 3 is a trunnion bore 20, into which a trunnion affixed to the ball may be inserted. The entire ball and trunnion component (not shown) may fit into the unibody ball valve case 30 through the case opening 31, such that the distal trunnion, as depicted in FIG. 4, extends through the trunnion bore and the proximal trunnion extends beyond the circumference of the unibody ball valve case. Once the ball and trunnion component is fitted into the unibody ball valve case 30, the case opening 31 may be closed with a valve cap 32. The valve cap 32 will generally be the same thickness of the unibody ball valve case and will fit within dimensions of the case opening such that little or no space is between the fitted valve cap and the case opening. The valve cap 32 may possess a trunnion bore 20 such that the proximal trunnion extends through the valve cap 32. The valve cap can be affixed to the unibody ball valve case 30 by welding the seam between the valve cap and the case opening. Alternatively, the valve cap 32 may include an overlap on the proximal side of the valve cap allowing the cap both fit within the case opening and be bolted to the unibody ball valve case.

Also shown in FIG. 3 are threaded bolt holes 15 along one opening of the unibody ball valve case 30 and interior threading 33 along another opening of the unibody ball valve case 30. In implementation, both sides may have threaded bolt holes 15 such that the unibody ball valve case 30 may be bolted to pipe flanges. Alternatively, the unibody ball valve may possess interior threading 32 at both ends such that corresponding pipe with exterior threading may be screwed into the unibody ball valve case.

The ball and trunnion component 40 is more fully illustrated in FIG. 4. More specifically, the ball and trunnion component has ball 41 with a throughbore 42 for flow of liquids. Perpendicular to this throughbore 42 is a trunnion axis comprising a proximal trunnion 43 and a distal trunnion 44. More specifically, the proximal trunnion 43 and the distal trunnion 44 are affixed to the ball 41. At the distal end of each trunnion is a turn wheel mount 45. The turn wheel mounts 45 will preferably allow the turn wheel to be affixed to the trunnions. The turn wheel mounts 45 may be a threaded to receive a nut to secure a turn wheel in place. Alternatively, each of the turn wheel mounts 45 may be deformed upon mounting of the turn wheel such that the turn wheel may not be removed from the trunnion. In certain embodiments, the turn wheel mount is tapered and contains a number of edges such as four or six edges. The center of the turn wheel may have a corresponding receptor with the appropriate shape to receive the turn wheel mount such that the turn wheel mount fits snugly with the turn wheel.

Additionally in FIG. 4, the trunnions may be affixed to the ball in the process of forging, casting, machining or by welding the trunnions to the ball. Alternatively, each trunnion may have wedge shaped trunnion connector 47 to allow each trunnion to slide into a retaining groove 48 on the face of the ball. In certain embodiments, one or more trunnion may further possess a trunnion axial movement dampener 49 to further prevent movement along the trunnion axis when the ball and trunnion component is within a ball valve case. However, this trunnion axial movement dampener may not be used in every embodiment.

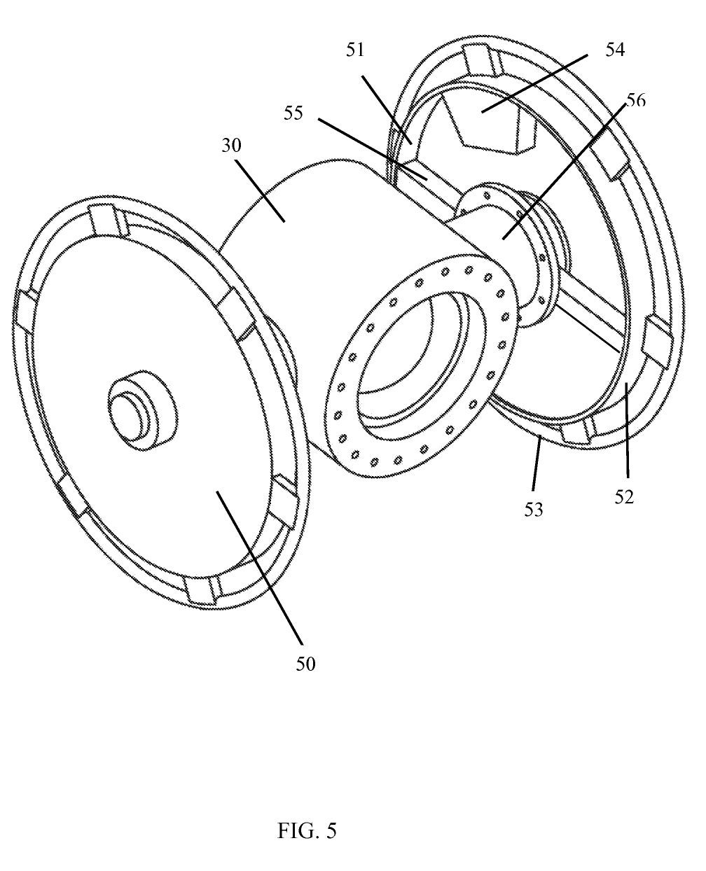

As shown in FIG. 5 is a completed ball valve of the present invention employing a unibody ball valve case 30. Two impact turn wheels 50 are affixed to the trunnions. While it is contemplated that in many embodiments, each trunnion will be affixed to an impact turn wheel, there are other embodiments readily conceived wherein only one turn wheel is needed or desired. The impact turn wheels have an inner wall 51 and an outer wall 52. Affixed to the outer wall are handles 53 and affixed to the inner wall is a hammer 54. Additionally, the impact turn wheels have strike bars 55 such that rotation of the turn wheel causes impact of the hammer against the strike bar. The strike bar in turn is affixed to the trunnion such that the trunnion will rotate the ball upon impact of the hammer against the strike bar. Alternatively, the strike bars can also be directly affixed to the impact turn wheel, which is in turn attached to a trunnion. In this instance impact of the strike bar with the hammer would result in torque being applied to the trunnions as well. The trunnions are protected from being bent or cleaved by the attachment of trunnion protecting sheathes 56 to the valve case and the valve cap.

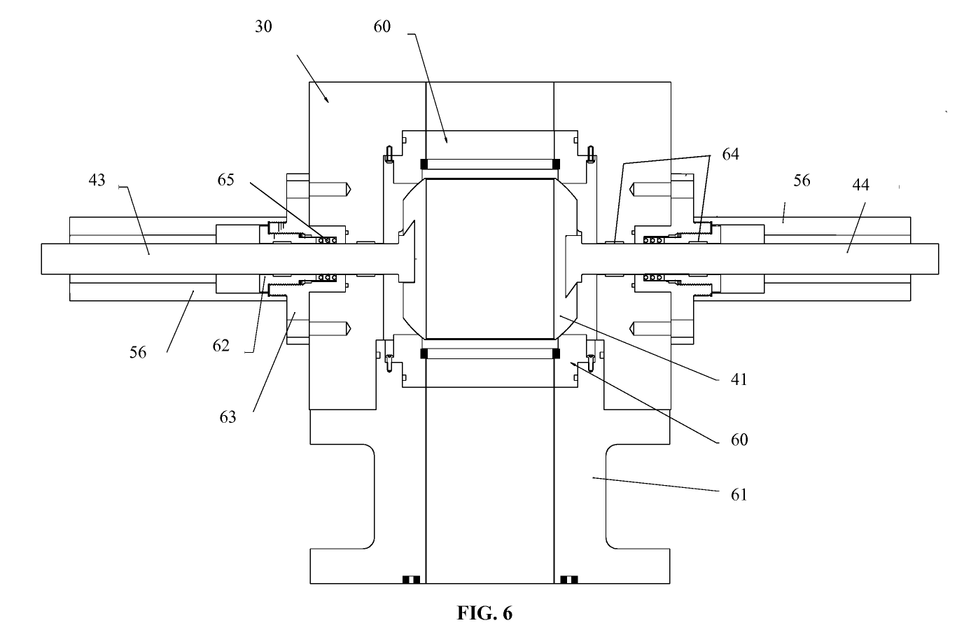

FIG. 6 is a cross section of an alternative embodiment of the ball valve design. In this embodiment, the proximal 43 and distal 44 trunnions may be viewed as being attached to the ball 41 via the wedge shaped trunnion connector sliding into the retaining grooves on the ball. This embodiment allows a ball without trunnions to be placed into the ball valve case 30 and positioned between the two trunnions by sliding the wedge shaped trunnion connectors into the retaining grooves. The ball can then be enclosed in the ball valve case by the positioning of ball valve seats 60. Preferably, a ball valve seat is used on both sides of the ball. However, it is contemplated that the ball valve case may itself retain the ball as it is positioned within the ball valve case 30 so that only one seat is employed. Covering the seat in some embodiments may be an end closure 61 with a proximal end toward the seat and a distal end away from the seat. The distal end of the end closure can be welded, bolted or otherwise affixed to pipe. Alternatively or additively, pipe may be directly affixed to the valve case as illustrated in previous embodiments. In this embodiment, but contemplated for other embodiments, wear bushings 64 may at least partially surround the trunnions. Still further, bearings 65 may at least partially surround the trunnions as they exit the trunnion bores. A trunnion bore may further comprise a packing gland 62 which is affixed to a bonnet 64.

Impactor handwheels utilized in the present invention are ideally suited for providing increased force for rotating a ball valve. As is well known, force equals mass times acceleration. In a typical ball valve design, there is typically little force applied to closing the valve other than that a constantly supplied force by a motor or by the muscles of the operator. In contrast, the quick rotation of an impactor handwheel provides a fast acceleration of the hammer of the handwheel until it impacts the strike bar of said handwheel. Accordingly, the rapid acceleration associated with the free rotation of the impactor handwheel combined with the mass of the impactor handwheel hammer provides a great force against the strike bar of the handwheel, thus causing trunnions and ball to rotate within the ball valve. This can be thought of as torque. Torque, moment or moment of force, is the tendency of a force to rotate an object about an axis, fulcrum, or pivot. Just as a force is a push or a pull, a torque can be thought of as a twist. In applications of the present invention, torque equals the length of the strike bar from the radius to the impact location times the actual force applied. Thus impactor handwheels of the present invention can have greater torque by faster rotation of the handwheel prior to its impact against the strike bar, a larger diameter of the impactor handwheel, or both. For example, various embodiments of the valves of the present invention may have impactor handwheels 1×, 2×, 3×, 4× or greater than the diameter of the ball within the ball valve.

Valves of the forgoing description are ideally suited for use in environments of high pressure. For example, various embodiments of valves of the present invention are useful in environments of pressures ranging from about 1 pound per square inch (psi) to 50,000 psi. In an alternate embodiment, valves of the present invention are useful in environments of pressures ranging from about 100 psi to about 40,000 psi. In an alternate embodiment, valves of the present invention are useful in environments of pressures ranging from about 1000 psi to about 20,000 psi. In an alternate embodiment, valves of the present invention are useful in environments of pressures ranging from about 5000 psi to about 15,000 psi.

Valves of the forgoing description are ideally suited for use in environments of high temperature. For example, various embodiments of valves of the present invention are useful in environments of temperatures ranging from about 1 degree Fahrenheit (° F.) to 2,500° F. In an alternate embodiment, valves of the present invention are useful in environments of temperatures ranging from about 100° F. to about 1,500° F. In an alternate embodiment, valves of the present invention are useful in environments of temperatures ranging from about 200° F. to about 1,000° F. In an alternate embodiment, valves of the present invention are useful in environments of temperatures ranging from about 250° F. to about 500° F.

Valves of the forgoing description additionally ideally suited for use in upstream petroleum production environments. For example, various embodiments of the valves of the present invention are useful in fracking operations. In other embodiments of the present invention, the ball valves are useful when positioned above a wellhead in a “Christmas tree” configuration comprising an aggregation of numerous valves to control pressure and flow of fluids during pumping operations. Ball valves with impactor handwheels provide a greater advantage over existing gate valves due to the speed of opening and closing ball valves as compared to the length of time required to open and close gate valves.

From the foregoing description, one of ordinary skill in the art can easily ascertain the essential characteristics of this disclosure, and without departing from the spirit and scope thereof, can make various changes and modifications to adapt the disclosure to various usages and conditions. For example, references such as above, below, left, right, and the like are not meant as limiting but rather as a guide for orientation of the referenced element to another element. It will be understood that certain of the above-described structures, functions, and operations of the above-described embodiments are not necessary to practice the present disclosure and are included in the description simply for completeness of an exemplary embodiment or embodiments. In addition, it will be understood that specific structures, functions, and operations set forth in the above-described referenced patents and publications can be practiced in conjunction with the present disclosure, but they are not essential to its practice.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes to the claims which come within the meaning and range of equivalency of the claims are to be embraced within their scope. Further, all published documents, patents, and applications mentioned herein are hereby incorporated by reference, as if presented in their entirety herein.

What is claimed is:

1. A ball valve comprising:
a ball valve case having a first valve bore and a second valve bore;
a ball situated within said ball valve case and said ball comprising a throughbore defining a flow axis;
a first trunnion having a proximal end attached to said ball and a distal end extending away from said ball and across said ball valve case through a first trunnion bore;
a second trunnion having a proximal end attached to said ball and a distal end extending away from said ball and across said ball valve case through a second trunnion bore, wherein said first trunnion and said second trunnion define a trunnion axis; and,
a first impactor turn wheel attached about said distal end of said first trunnion and a second impactor turn wheel attached about said distal end of said second trunnion, wherein each of said first impactor turn wheel and said second impactor turn wheel comprise one or more hammers and one or more strike bars, and wherein
when the flow axis of said throughbore is at least partially aligned with respect to the flow axis of said first valve bore and said second valve bore, a fluid is capable of flowing through the ball valve case.

2. The ball valve of claim 1, wherein said proximal end of said first trunnion is attached to said ball by machining, casting or forging.

3. The ball valve of claim 1, wherein said proximal end of said first trunnion has a wedge shaped trunnion connector and the ball has a retaining groove.

4. The ball valve of claim 1, wherein said ball valve case comprises a valve bore flow axis and having a diameter less than a diameter of said ball.

5. The ball valve of claim 1, wherein said ball consists essentially of an incompressible material.

6. The ball valve of claim 5, wherein the incompressible material is an steel alloy.

7. The ball valve of claim 1, wherein the ball valve case comprises a first half and a second half, wherein each of said first half and said second half comprises a proximal end and a distal end, the proximal end of each of said first half and said second half comprising a flange bifurcated by two semicircular notches 180 degrees apart wherein attachment of said first half and said second half define at least one trunnion bore.

8. The valve of claim 7, wherein at least a portion of the length of said first trunnion extending across said valve case is protected by a trunnion protecting sheathe attached to the exterior of the valve case and extending at least partially to said distal end of said trunnion.

9. The valve of claim 1, wherein said ball valve case is a unibody ball valve case capable of receiving a ball.

10. The valve of claim 9 wherein the trunnions possess wedge shaped trunnion connectors which are affixed to retaining grooves on the ball when the ball is received by the ball valve case.

11. The valve of claim 9, further comprising a seat adjacent to the ball and within the ball valve case.

13. The valve of claim 10, wherein at least a portion of the length of said first trunnion extending across said valve case is protected by a trunnion protecting sheath attached to the exterior of said valve case.

14. The valve of claim 1, wherein each trunnion bore is surrounded by a bonnet.

15. The valve of claim 14, wherein a packing gland is affixed to the bonnet.

16. The valve of claim 14, wherein each trunnion is at least partially surrounded by one or more wear bushings.

17. The valve of claim 14, wherein each trunnion is at least partially surrounded by bearings.

18. A high pressure control system comprising a valve of claim 1 for adjusting the flow of a fluid from an upstream high pressure environment to a downstream lower pressure environment.

19. A system comprising an inlet conduit affixed to the first valve bore of claim 1 and an outlet conduit affixed to the second valve bore of claim 1 in a fracking operation for changing a pressure of a fluid flowing from the inlet conduit, through the valve and to the outlet conduit; wherein the pressure of the fluid flowing though the outlet conduit is changed from 0 psi to the about the same pressure of the fluid flowing from the inlet conduit or vice versa.

20. A system comprising an inlet conduit affixed to the first valve bore of claim 1 and an outlet conduit affixed to the second valve bore of claim 1 in a Christmas tree petroleum producing apparatus mounted above a wellhead for changing a pressure of a fluid flowing from the inlet conduit, through the valve and to the outlet conduit, wherein the pressure of the fluid flowing through the outlet conduit is changed from about 0 psi to about the same pressure of the fluid flowing from the inlet conduit or vice versa.
